(19) United States
(12) Patent Application Publication
(10) Pub. No.: US 2015/0287333 A1
(43) Pub. Date: Oct. 8, 2015

(54) VIRTUAL FORENSIC EDUCATIONAL LAB ACTIVITY AND REAL-WORLD KIT

(71) Applicant: John Stevens, Riverhead, NY (US)

(72) Inventor: John Stevens, Riverhead, NY (US)

(21) Appl. No.: 14/681,745

(22) Filed: Apr. 8, 2015

Related U.S. Application Data
(60) Provisional application No. 61/976,662, filed on Apr. 8, 2014.

(51) Int. Cl. G09B 9/00; G09B 7/02; G09B 3/02; G09B 19/00

(52) U.S. Cl. CPC G09B 9/00; G09B 19/0046; G09B 7/02; G09B 3/02; G09B 19/00

(57) ABSTRACT

A program for teaching forensic science may include physical devices or an online internet activity simulating a crime scene, preferably a crime scene based on a notable crime that has actually occurred and received some notoriety. A virtual classroom is provided which includes lessons in forensics and quizzes, a virtual lab to study evidence by the user, and an easy-to-use interface for teachers to manage their presentations and monitor the progress of students studying forensic science.

### CROSS REFERENCE TO RELATED APPLICATIONS

This application is based on provisional application Ser. No. 61/976,662 filed Apr. 8, 2014.

### FIELD OF THE INVENTION

The present invention relates to an interactive educational program that can be hosted on the internet to enable an enhance learning of forensic science; and companion physical learning kits for forensic science.

### BACKGROUND OF THE INVENTION

Due largely to popular television shows, the field of forensic science, particularly as it relates to investigation of crime scenes, has become increasingly popular. It is, therefore, an object of the present invention to enable and enhance the learning of forensic science techniques, and to utilize the internet to increase access to those who may desire to undertake the study of forensics. Forensic Science enables the learning of all science through the application of the “scientific method” by requiring close observation and data recording regarding evidence at the crime scene, which is then studied in the lab. Additionally, physical leaning kits can be provided to enable forensic science to be taught in a group setting, such as a classroom.

### SUMMARY OF THE INVENTION

According to the present invention, an online activity is provided that includes a crime scene, preferably a crime scene based on a notable crime that has actually occurred and received some notoriety. The crime scene is given a title, such as The Murder at Old Fields and representations are provided to simulate the murder scene with a unique three-dimensional crime scene the user can explore. A virtual classroom is provided which includes lessons in forensics and quizzes, a virtual lab to study evidence by the user, and an easy-to-use interface for teachers to manage their presentations and monitor the progress of students studying forensic science. The program for teaching forensics may be online or in a physical kit form, and provides an experience of learning by discovery with assistance and guidance from a teaching professional.

The online version of the interactive program provides:
1. Lessons that teach the real forensic science according to state and national science standards;
2. Quizzes auto-graded to quickly and easily gauge a student's mastery of the science lessons.
3. Discovery of the evidence at the 3D crime scene of a historically-accurate crime scene, such as a rural American 19th Century farmhouse representing the scene of the double murder at Old Fields, Long Island in 1842.
4. Lab activities to analyze evidence, record data and apply the scientific method to solve problems through a compelling and engaging use of the most advanced online tools available.
5. Easy to use accounts where students can assess their results and teachers can monitor student performance. Teachers can choose to enable some or all of the lab activities to accommodate the class schedule and help students learn through discovery, at their own pace.
6. Meticulously crafted to reflect the facts of a known case, preferably a cold case from long ago. By choosing a crime scene from a bygone era, the program can also provide an ideal interdisciplinary/cross-curricular learning experience, for example, with a rich immersion in American history and a strong narrative of the crime and the time.

It is envisioned that an actual activity kit can be provided as a companion teaching tool that is directed to the same crime scene scenario to enable actual lab activity to complement the virtual lab activity, or be used independently.

These and other objects, and advantages and features of the present invention will become apparent from the description given below which is made in conjunction with the following drawing figures:

### BRIEF DESCRIPTION OF THE DRAWINGS

FIG. 1 is a schematic diagram of a interactive educational program to enable learning of forensic science according to the present invention;

FIG. 2 is a flow chart for the computer program for an interactive educational program that can be hosted on the internet to enable an enhance learning of forensic science.

### DETAILED DESCRIPTION OF AN EMBODIMENT

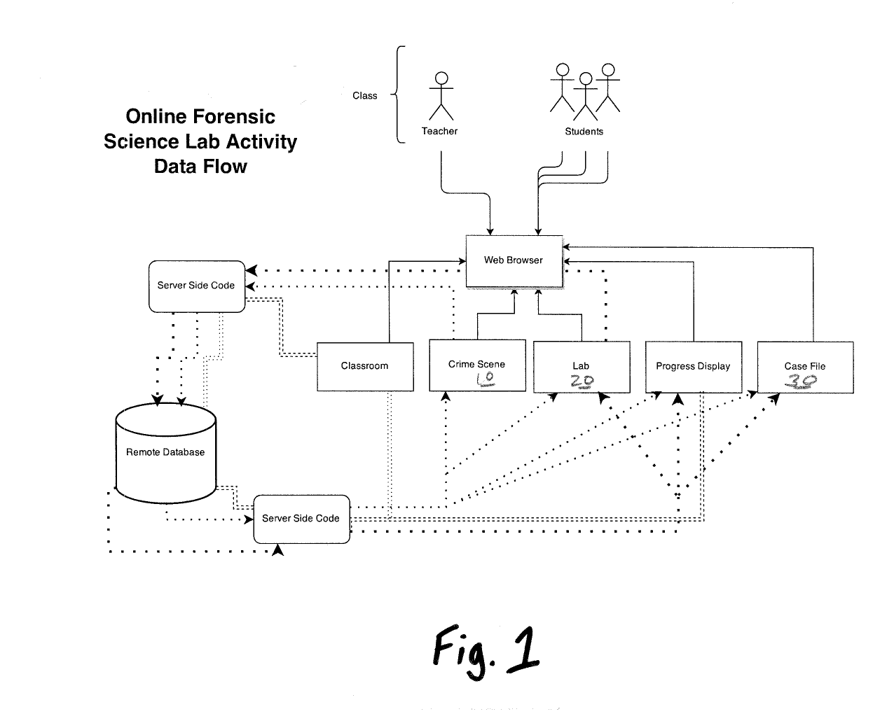

The present invention is a program for teaching forensic science and in one form includes software hosted by a provider so that prospective users have no need to themselves acquire or install software, and the program can be accessed by conventional internet browsers. As illustrated in FIG. 1, the program to be used in is the present invention stores data to illustrate on the user's computer that will represent the crime scene 10 including the facts, evidence and details of a crime scene, preferably an historic murder. The tools and techniques of modern forensic science are applied through data blocks 20 and 30 requiring the user/student to apply forensic techniques to assist the learning of the scientific method, scientific inquiry and the hard sciences associated with forensic investigations.

In a preferred embodiment of the present invention, cross-curricular activity can be provided that may include primary source historical documents—such as trial transcripts—from an actual crime to encourage literacy and the learning of

American history by the students.

The activity flow experienced by users:
1. Teachers can create a free account by accessing a predetermined web address.
2. A teacher may add student accounts to their teacher account, they can do so by purchasing student accounts using a credit card or with a purchase order from their school.
3. The teacher can then assign these student accounts to his/her students.
4. Students log-into their accounts through the interface at the predetermined web address.
5. Students can then begin the activity.
6. Students would likely start at Lesson #1—called “The Crime.” This lesson introduces the student to the historic crime; as an example a crime which occurred in Old Fields, Long Island in 1842.
7. Students then read about the crime, and take the online self-graded quiz to test their mastery of the material.
8. The results of this quiz automatically get recorded in their online account and marks their progress in the online “Grade book.”
9. At any time during this process, the teacher can log into his/her account to see the progress of any of his/her students in the online “Grade book.”
10. After completing the lesson called “The Crime,” the student would then likely move onto any of the other seven lessons in the activity, including the science lessons/labs, such as “Hair Analysis.”
11. To accomplish the science Lesson/Labs, the student would first read the “online lesson” and take the online quiz, much like they would have done for “The Crime.”
12. Then the student moves into the “Crime Scene” delivered through a conventional browser where they explore the 3D online crime scene using their internet browser. The user may view the crime scene from many differing angles and perspectives, much like one would use a video to view a potential hotel room or apartment to rent, or a video-game-like experience.
13. The students are prompted to stop at various “stations” at the crime scene and use the available online tools—such as tweezers or a cotton swab—to collect evidence at the crime scene by the techniques preferred for criminal investigations.
14. This evidence is stored in the student's online “Evidence Drawer.”
15. When all the evidence of a particular type is gathered (such as all the hair samples) the student may then elect to go to the online “Lab” where he/she can use virtual instruments (such as a virtual microscope) to examine the evidence and record his/her results.
16. In the lab, the student examines the “Control Samples” for each of the victims and the suspects in the case and records that data. In the example, this would include the two victims and four suspects.
17. Then the student examines the “Evidence” found earlier at the crime scene and records that data.
18. Once all the data for a particular lab is recorded, the lab report is “submitted” by the student and it is “auto-graded” by the program.
19. Again, at any time during this process, the teacher can monitor the progress of the student as he/she is recording data in the online “Grade book.”
20. The student would then go through each of the other labs in turn, such as Blood Typing, DNA, Fingerprint Analysis, and Shoe Impressions.
21. At any time in the process, students can visit the “Case File” segment of the lab activity to see and visual representation of the evidence they have found at the Crime Scene and the data and conclusions they have assigned to that evidence in the online lab.
22. The teacher can choose to Enable or Disable any or all of these Lesson/Labs depending upon the type of experience he/she wants to provide for the students.
23. There are also two “summary” Lesson/Labs that are generally enabled at the end of the experience for the user—“Choose the Culprit” and “Historical Documents.”
24. In the “Choose the Culprit” Lesson/Labs, the students are encouraged to choose who they thought committed the crime based on the evidence they found at the crime scene and how it matched up with the control samples for the two victims and four suspects. A short written report on this is created by the student and submitted online to the teacher who grades it.
25. In the “Historical Documents” Lesson/Labs, the students are encouraged to read the historic documents included in this lesson—such as the trial transcript from the actual trial in 1843—and, based on the evidence they collected in the virtual crime scene and their analysis of it in the virtual lab, to write a short written report as to whether the student believes that in fact the right person was tried, convicted and hung for the crime. This report gets submitted online to the teacher who grades it.

And a physical forensic investigative kit including samples and lab experiments can be provided to compliment the on-line presentation.

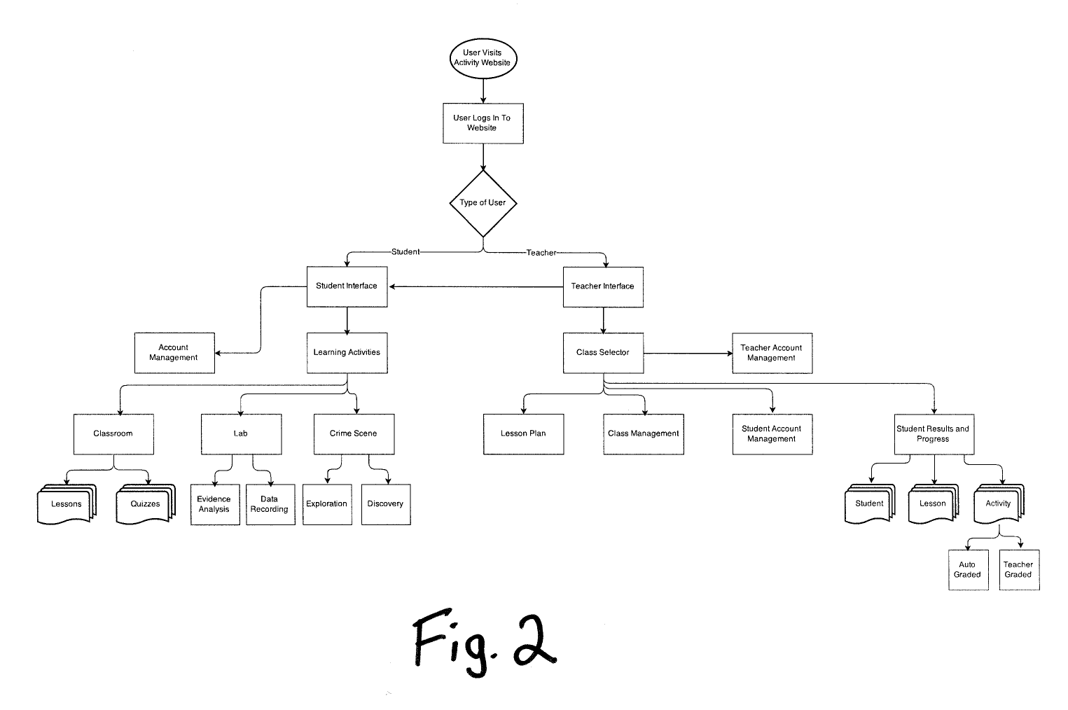

These various steps in the lesson are illustrated in FIG. 2.

In preferred form of the teaching program of the present invention, the forensic lessons applied are virtual by use of computers and the internet. However, it is understood that the program of the present invention combining lessons from actual crime scenes and forensic investigation methods can be provided in physical form as a kit to be used in conjunction with the online version, or independently.

It is to be understood that different crime scenes or differing forensic tools and lab reports could be provided and still be within the spirit and scope of the present invention.

What is claimed is:

1. An interactive program for studying forensic science techniques, including providing to students materials to represent the scenario of a crime scene, and providing to the same students the forensic tools to examine evidence presented at the crime scene.

2. An interactive program for studying forensic science techniques as set forth in claim 1, the materials to represent the scenario of said crime scene represent a notable crime that has actually occurred.

3. An interactive program for studying forensic science techniques as set forth in claim 2, including an examination to the students to ascertain the knowledge of the crime scene.

4. An interactive program for studying forensic science techniques as set forth in claim 1, including the students gather evidence presented from the crime scene and provide forensic techniques to examine the evidence and record the results.

5. An interactive program for studying forensic science techniques as set forth in claim 1, said program including computer software to simulate the crime scene and having several stations representing actual features of the crime scene, and prompt the students at such various stations of the crime scene to use available online tools simulating the collection of evidence at the crime scene.

6. An interactive program for studying forensic science techniques as set forth in claim 5, including software enabling the students to gather evidence virtually presented from the crime scene and provide a virtual laboratory to apply forensic techniques to examine the evidence to produce results.

7. An interactive program for studying forensic science techniques as set forth in claim 6, including software to enable each student to record said results and generate a lab report based on said results.

8. An interactive program for studying forensic science techniques as set forth in claim 7, the materials to represent the scenario of said crime scene provide a virtual scene to represent a notable crime that has actually occurred.

9. An interactive program for studying forensic science techniques as set forth in claim 8, software providing historic documents relating to the scenario of said crime scene and software enabling the students to review said historic documents and, based on the evidence they collected and their report in the virtual lab, provide an analysis as to whether the student believes that in fact the right person was tried, and convicted for the crime.
